(19) United States
(12) Patent Application Publication
(10) Pub. No.: US 2006/0206945 A1
(43) Pub. Date: Sep. 14, 2006

(54) Method, apparatus and program for protecting content

(76) Inventors: Taku Kato, Kamakura-shi (JP); Atsushi Ishihara, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/154,716

(22) Filed: Jun. 17, 2005

(30) Foreign Application Priority Data
Jun. 18, 2004 (JP) 2004-181100

(51) Int. Cl. H04L 9/32

(52) U.S. Cl. 726/27

(57) ABSTRACT

According to a first aspect of the present invention, a recording medium manufactured without using the latest key management information can be detected and accuracy of content protection can be improved. A license association apparatus generates a digital signature uniquely corresponding to the latest key management information and content data. A disc manufacturer apparatus writes this digital signature together with the key management information, encrypted content, content feature information onto a DVD. Accordingly, the recording media manufactured without using the latest key management information can be detected by confirming unique correspondence among the key management information, the content feature information and the digital signature and unique correspondence between the encrypted content and the content feature information, in advance of playback.

### CROSS-REFERENCE TO RELATED APPLICATIONS

This application is based upon and claims the benefit of priority from prior Japanese Patent Application No. 2004-181100, filed Jun. 18, 2004, the entire contents of which are incorporated herein by reference.

### BACKGROUND OF THE INVENTION

1. Field of the Invention

The present invention relates to a method, an apparatus and a program for protecting content to protect computerized content from illegal playback. More specifically, the invention relates to a method, an apparatus and a program capable of detecting a recording medium (recordable and/or prerecorded medium) manufactured without using the latest key management information.

2. Description of the Related Art

In recent years, a method for protecting content has become used to protect content from illegal playback caused by unauthorized copying when recording content data (hereinafter, referred to as content) of a movie, music, etc., on a recording medium such as a digital versatile disc (DVD).

As such a kind of method for protecting content, for example, the content protection for prerecorded media (CPPM) technique used for DVD-Audio is known widely. (For example, refer to 4C entity, LLC, internet, <URL: http://www.4 Centity.com/>) The CPPM technique records content encrypted in advance onto a recording medium, makes the recorded content impossible to be reproduced by unauthorized playback equipment. The CPPM technique, then, has an advantage enabling unauthorized equipment to be disabled. As used herein, the unauthorized equipment means equipment with a protection technique conducted to the content removed there from, and equipment with an altered protection technique or equipment possible to alter its protection technique.

The above-described CPPM technique can be conducted by becoming a licensee for technical license by entering in advance into a license agreement between a media manufacturer who manufactures a recording medium such as the DVD-Audio disc and a license association (key management information issuing association). Hereinafter, the CPPM technique will be explained by referring to the DVD as a representative example of recording media and to a disc manufacturer as a representative example of a media manufacturer.

FIG. 1 is a schematic diagram showing a configuration of a disc manufacturer apparatus and a license association apparatus applicable to the method for protecting content using the CPPM technique.

A disc manufacturer apparatus 10 transmits an issue request for a plurality of pieces of key management information (hereinafter, referring to as a key management information set) in advance from an issue requesting unit 12 to a license association apparatus 20 in accordance with an operation of the disc manufacturer. Here, in CPPM, the key management information set corresponds to a pack of a media key block (MKB). The disc manufacturer does not request for issuing the key management information one by one at every manufacturing of the DVD of one album but requests for issuing in advance by setting an extent of the number of pieces of the key management information.

The license association apparatus 20 generates key management information sets MKB1-MKBn composed of n pieces of the key management information by means of a key management information generation unit 21 according to the issue request. Suites (MKB1, Km1), (MKB2, Km2), to (KMBn, Kmn) of the key management information sets MKB1-MKBn and media keys Km1-Kmn managed at every MKB1-MKBn are sent back to the disc manufacturer apparatus 10 from the license association apparatus 20.

The disc manufacturer apparatus 10 stores the suites of the key management information sets MKB1-MKBn and the media keys Km1-Kmn into a storage device 13. When manufacturing the disc, the disc manufacturer apparatus 10 selects to utilize appropriate key management information MKBi (where, 1≦i≦n) among the key management information sets MKB1-MKBn.

That is to say, the disc manufacturer apparatus 10 selects, for example, one of the key management information set MKB1 which has not used yet from a storage device 13 by means of a key management information set selection unit 14 and transmits the media key Km1 managed (protected) by this key management information MKB1 to an encryption unit 15.

The encryption unit 15 encrypts content data in a content data storage unit 11 on the basis of the media key Km1 to acquire encrypted content data. Then, the disc manufacturer apparatus 10 writes the key management information set MKB1 and the acquired encrypted content data into a DVD 30.

Thereby, the manufacturing of the DVD 30 is completed. Hereinafter, a large number of DVDs 30 are copied by using this manufactured DVD as a master disc.

This DVD 30 refers to the key management information MKB to decrypt the encrypted content data, when performing playback. The key management information MKB is information to disable the unauthorized equipment. More specifically, the key management information MKB is information to prevent decryption of the encrypted content in the DVD 30 against the unauthorized equipment recognized at the time when the license association issued the key management information MKB.

Accordingly, when the DVD 30 is reproduced, the unauthorized equipment is rejected and only authorized equipment is allowed to decrypt the encrypted content.

A conventional method for protecting content disables unauthorized equipment recognized by the key management information MKB issued from the license association at the issuing time thereof.

Therefore, at the time of disc manufacturing, from a standpoint of efficiently disabling the unauthorized equipment one and all, it is necessary to use the latest key management information with information about all of the unauthorized equipment which becomes clear currently reflected therein.

On the other hand, even without using the latest information, but by using, for example, the earliest key management information MKB with the unauthorized equipment has not disabled therein, the DVD 30 can be manufactured. This possibility of manufacturing is originated from the fact that determination which key management information should be used is entrusted to the disc manufacture. However, it is prohibited for the disc manufacturer to use the same key management information repeatedly or use old key management information in accordance with conditions of the license agreement.

However, according to study by an inventor of the present invention, technical means to prevent a way to use the key management information inhibited by the license agreement has not prepared yet. Consequently, such a method for protecting content can not reject at least the unauthorized equipment recognized recently and deteriorates accuracy of content protection.

### BRIEF SUMMARY OF THE INVENTION

An object of the invention is to provide a method, an apparatus and a program for protecting content, capable of detecting recording media manufactured without using the latest key management information and improving accuracy of content protection.

The another object of the invention is to provide a playback apparatus and a program capable of preventing recording media manufactured without using the latest key management information from being reproduced and improving the accuracy of the content protection.

According to a first aspect of the invention, there is provided a method for protecting content using a key issuing device for issuing key management information and a media key corresponding to each other, and a media manufacturing apparatus for manufacturing recording media by recording encrypted content in which content data is encrypted to be decrypted on the basis of the media key and the key management information so as to generate the media key by means of an authorized playback device other than an unauthorized playback device onto recording media so as to prevent the encrypted content from being played by the unauthorized playback device, the method comprising: generating the latest uniquely corresponded data uniquely corresponding to the latest key management information and the content data by means of the key issuing device in advance of manufacturing of the recording media; and writing the latest uniquely corresponded data together with the key management information and the encrypted content to the recording media by means of the media manufacturing apparatus.

According to a second aspect of the invention, there is provided a media manufacturing apparatus for manufacturing recording media by recording an encrypted content in which content data is encrypted to be decrypted on the basis of a media key and key management information so as to generate the media key by means of an authorized playback device other than an unauthorized playback device onto recording media, the media manufacturing apparatus being in communication with a key issuing device, the key issuing device capable of issuing key management information and a media key corresponding to each other and generating the latest uniquely corresponded data uniquely corresponding to the issued key management information and the content data, the media manufacturing apparatus comprising: a content correspondence data generation device configured to generate content correspondence data composed of a data amount smaller than that of the content data and uniquely corresponding to the content data; a key issue request transmitting device configured to transmit a key issue request including the content correspondence data to the key issuing device; a latest information reception device configured to receive the latest key management information, the media key and the latest uniquely corresponded data from the key issuing device in accordance with transmission of the key issue request; an encrypted content generation device configured to generate the encrypted content on the basis of the media key; and a writing device configured to write the encrypted content, the latest uniquely corresponded data, the latest key management information and the content correspondence data onto the recording media.

According to a third aspect of the invention, there is provided a media manufacturing apparatus for manufacturing recording media by recording encrypted content in which content data is encrypted to be decrypted on the basis of a media key and key management information so as to generate the media key by means of an authorized playback device other than an unauthorized playback device onto a recording media, the media manufacturing apparatus being in communication with a unique data generation device, the unique data generation device capable of generating the latest uniquely corresponded data uniquely corresponding to the latest key management information and the content correspondence data, the media manufacturing apparatus comprising: a storage device configured to store a plurality of pairs of key management information and the media key if necessary in a pair of key management information and the media key corresponding to each other; a key management information selection device configured to select any key management information stored in the storage device; a content correspondence data generation device configured to generate content correspondence data composed of a data amount smaller than that of the content data and uniquely corresponding to the content data; a unique data generation request transmitting device configured to transmit a unique data generation request including key management correspondence information uniquely corresponding to the selected key management information and the generated content correspondence data to the unique data generation device; a latest uniquely corresponded data reception device configured to receive the latest uniquely corresponded data from the unique data generation device; an encrypted content generation device configured to generate the encrypted content on the basis of the media key corresponding to the selected key management information; and a writing device configured to write the encrypted content, the latest uniquely corresponded data, the selected key management information and the content correspondence data onto the recording media.

According to a fourth aspect of the invention, there is provided a playback device for decrypting encrypted content and playing obtained content data on the basis of a recording media with: the encrypted content in which the content data is encrypted so as to be decrypted on the basis of a media key; content correspondence data composed of a data amount smaller than that of the content data and uniquely corresponding to the content data; the latest key management information so as to generate the media key; and the latest uniquely corresponded data uniquely corresponding to the key management correspondence information uniquely corresponding to the latest key management information and the content correspondence data recorded thereon, the playback device comprising: a first verification device configured to verify validity of the content correspondence data and key management information read from the recording media on the basis of the latest uniquely corresponded data read from the recording media; a content correspondence data generation device configured to generate the content correspondence data on the basis of the encrypted content data read from the recording media; a second verification device configured to verify validity of the generated content correspondence data on the basis of the content correspondence data in the recording media; and a playback prevention device configured to prevent the playback when at least one of verification results from the first and the second verification devices indicates an absence of the validity.

Accordingly, in the first aspect of the invention, a key issuing device generates the latest uniquely corresponded data uniquely corresponding to the latest key management information and content data in advance of manufacturing the recording media, and a media manufacturing apparatus writes the latest uniquely corresponded data together with the key management information and encrypted content onto the recording media. Accordingly, by checking whether the key management information and the encrypted content are uniquely corresponded to the latest uniquely corresponded data in advance of playing of the encrypted content, the playback apparatus can detect the recording media manufactured without using the latest key management information and improve the accuracy of the content protection.

In a second aspect of the invention, when a media manufacturing apparatus manufactures the recording media, the media manufacturing apparatus writes encrypted content, the latest uniquely corresponded data, the latest key management information and content correspondence data onto the recording media in a manner that the media manufacturing apparatus receives the latest key management information, a media key and the latest uniquely correspondence data from the key issuing device. Thereby, the media manufacturing apparatus can conduct operations similar to that of the first aspect.

In a third aspect, when the media manufacturing apparatus manufactures the recording media, the media manufacturing apparatus selects any key management information in a storage device and writes the encrypted content, the latest uniquely corresponded data, the selected key management information and the content correspondence data onto recording media. Thereby the media manufacturing apparatus can conducts the operations similar to that of the first aspect.

In a fourth aspect, a playback apparatus verifies validity of the content correspondence data and the key management information read from the recording media on the basis of the latest uniquely corresponded data read from the recording media to generate content correspondence data on the basis of the encrypted content data read from the recording media and verifies the validity of the generated content correspondence data on the basis of the content correspondence data in the recording media. Wherein, when at least one verification result shows an absence of the validity, the playback apparatus prevents playback. Accordingly, the recording media manufactured without using the latest key management information can be prevented from being reproduced and the accuracy of the content protection can be improved.

### BRIEF DESCRIPTION OF THE SEVERAL VIEWS OF THE DRAWING

FIG. 1 is a schematic diagram for explaining a conventional disc manufacturer apparatus and a license association apparatus;

FIG. 2 is a schematic diagram showing a configuration of a disc manufacturer apparatus and a license association apparatus with a method for protecting content regarding a first embodiment of the invention applied thereto;

FIG. 3 is a schematic diagram showing an example of key management information in the first embodiment;

FIG. 4 is a schematic diagram for explaining indexes and hash values composing content feature information in the first embodiment;

FIG. 5 is a schematic diagram for explaining the content feature information in the first embodiment;

FIG. 6 is a schematic diagram showing a configuration of a DVD player device in the first embodiment;

FIG. 7 is a flowchart for explaining operations in the first embodiment;

FIG. 8 is a flowchart for explaining operations of the DVD player device in the first embodiment;

FIG. 9 is a schematic diagram showing a configuration of a disc manufacturer apparatus and a license association apparatus regarding a second embodiment of the invention; and

FIG. 10 is a flowchart for explaining operations in the second embodiment.

### DETAILED DESCRIPTION OF THE INVENTION

Hereinafter, each embodiment of the invention will be explained by referring to drawings, however, a sketch of the invention will be described in advance of such explanation for the embodiments.

First, the sketch of the invention will be explained by referring to a license association apparatus (key issuing device, unique data generation device) and a disc manufacture apparatus (media manufacturing apparatus) as examples. The license association apparatus generates the latest uniquely corresponded data uniquely corresponding to the latest key management information and content data in accordance with a request from the disc manufacturer apparatus in advance of manufacturing of recording media and transmits the latest uniquely corresponded data to the disc manufacturer apparatus. The latest uniquely corresponded data can use arbitrary correspondence data such as a digital signature or a hash function with a key.

The disc manufacturer apparatus writes the latest uniquely corresponded data together with the key management information and the content data onto the recording media.

Thereby, a playback device can detect the manufactured recording media without using the latest key management information by confirming whether or not the key management information and the content data is uniquely corresponded to the latest uniquely corresponded data in advance of playback and improve accuracy of content protection.

This is the sketch of the invention. However, each embodiment uses the digital signature as the latest uniquely corresponded data. From a point of view to reduce a data amount of signature generation and signature verification, each embodiment uses key management information identification information with a data amount smaller than that of the key management information and content feature information with a data amount smaller than that of the content data. Accordingly, the each embodiment verifies the content feature information recorded on the recording media in addition to the signature verification.

Each embodiment of the invention will be explained below.

### First Embodiment

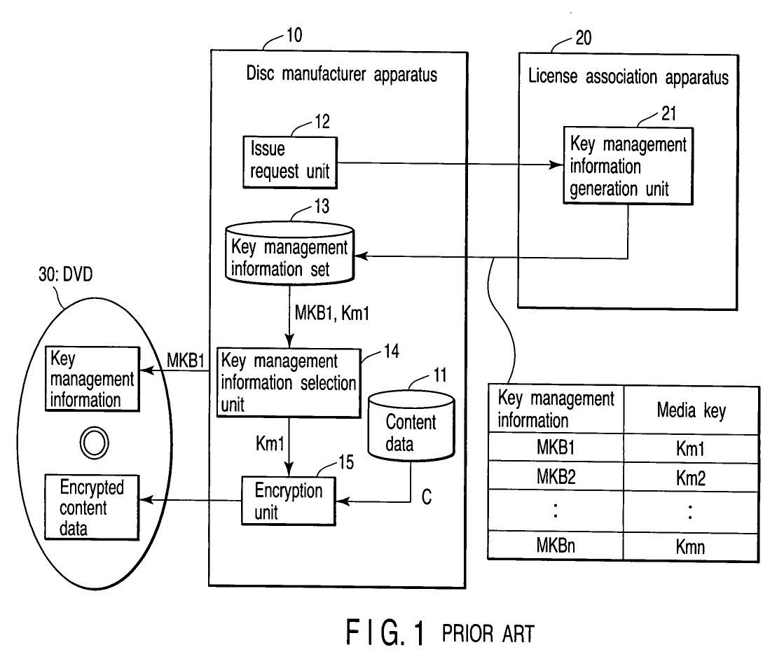

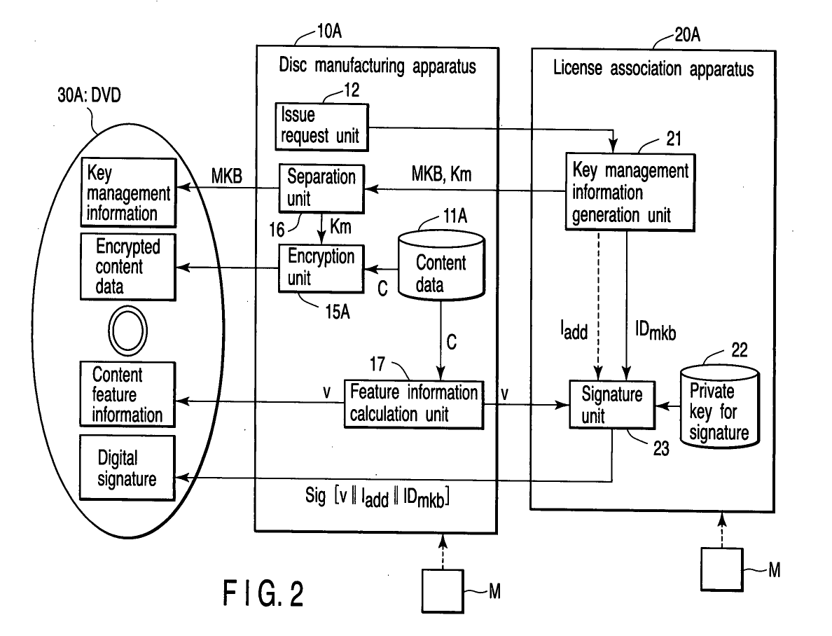

FIG. 2 is the schematic diagram showing the configuration of the disc manufacturer apparatus and the license association apparatus with the method for protecting content regarding the first embodiment of the invention applied thereto. In FIG. 2, like parts in FIG. 1 are given like symbols and detailed explanation will be omitted, then, different parts will be explained here. Even in relation to the following respective embodiments, redundant explanation will be eliminated.

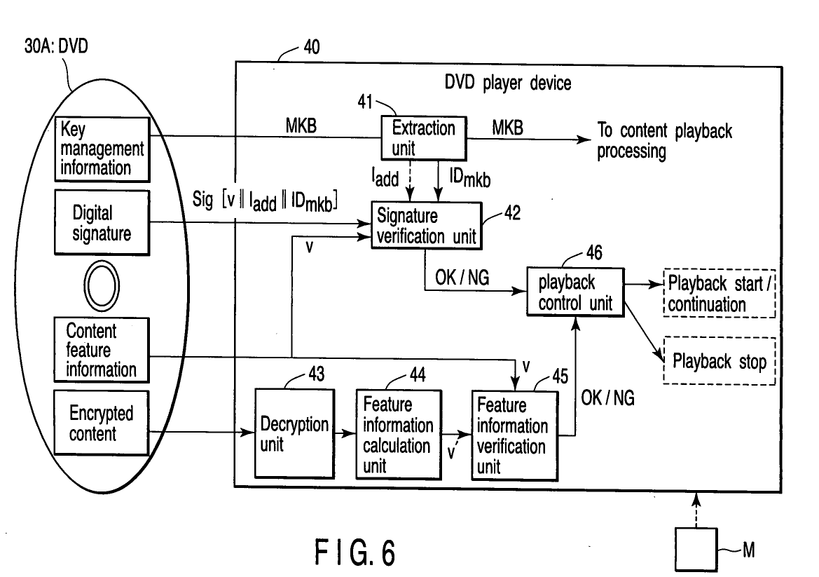

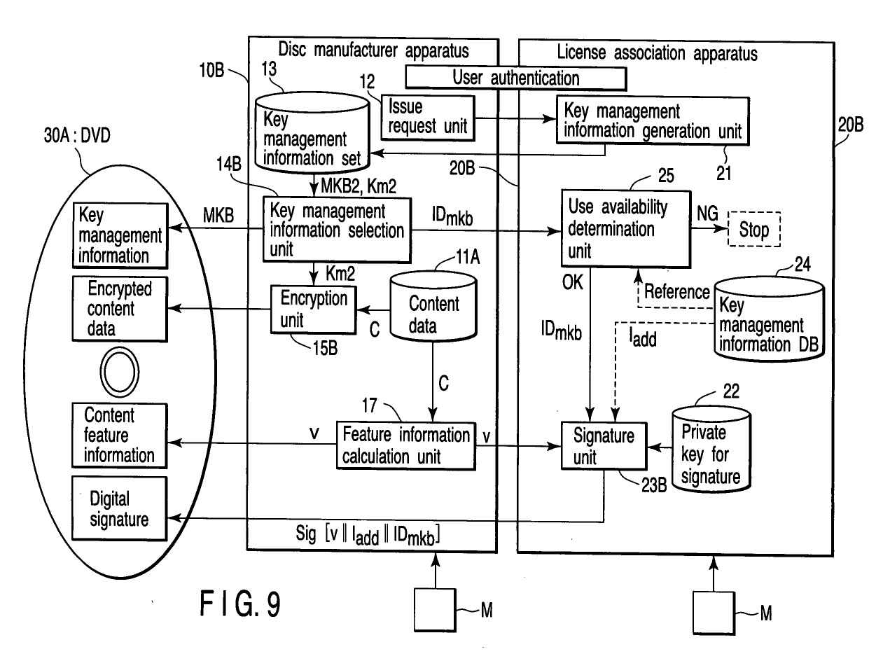

That is, the first embodiment enables detecting the recording media manufactured without using the latest key management information and improving the accuracy of the content protection. Specifically, the content feature information and the digital signature in addition to the key management information MKB and the encrypted content shown in FIG. 1 are recorded on a DVD 30A as an example of a recording medium. Accordingly, configurations of a disc manufacturer apparatus 10A and a license association apparatus 20A are modified. Each apparatus 10A, 20A is manufactured as a hardware configuration composed of each device or a combinational configuration of hardware and software to achieve its function. In the case of software, the software are manufactured as those which are, for example, programs to be installed into computers of each apparatus 10A, 20A from computer readable recording media M, respectively. Each apparatus 10A, 20A is manufactured as the hardware configuration or the combinational configuration of the hardware and the software. This fact goes same for other apparatus 40, 10B and 20B in this specification of the invention as shown FIG. 6 or FIG. 9 described later.

The disc manufacturer apparatus 10A has a separation unit 16 and a feature information calculation unit 17 instead of the storage device 13 and the key management information set selection unit 14 shown in FIG. 1. According to this, a storage device 11A and an encryption unit 15A input and output data to and from the separation unit 16 and the feature information calculation unit 17, so that the storage device 11A and an encryption unit 15A are indicated with adding subscripts A, respectively.

The separation unit 16 has a function to separate a media key from the received content and transmit it to the encryption unit 15A, when receiving the latest key management information, a media key and a digital signature from the license association apparatus 20A.

The key management information can apply an encrypted key set in a CPPM technique adopted in DVD-audio. Accordingly, it is assumed that a DVD player device mention later is manufactured under license, a decryption key (device key) for the key management information is stored in advance, and the DVD player device decrypts the encrypted content recorded on the DVD 30A, based on the key information acquired by decryption the key management information by using the device key.

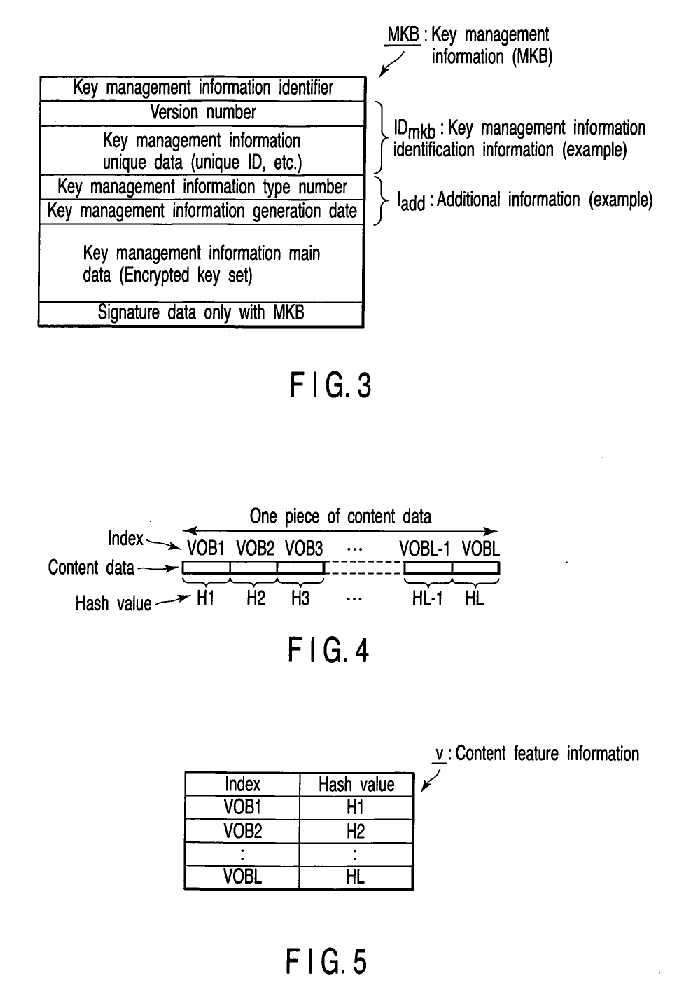

An example of a format of the key management information is shown in FIG. 3, however, it is not limited to this format. In FIG. 3, the key management information MKB is composed of a key management information identifier, a version number, key management information unique data, a key management information type number, key management information generation data, key management information main data (set of a plurality of encrypted media keys in which media keys are encrypted in parallel by device keys of respective playback devices), and signature data only of the key management information MKB. The version number capable of identifying a generation time point and the key management information unique data capable of identifying each key management information are made usable as, for example, key management information identification information ID_{mkb}. The key management information type and the key management information generation data are brought into usable as, for example, additional information I_{add}. In the case of making unauthorized equipment disabled, it is needed for the encrypted media key corresponding to the device key of the unauthorized equipment among a plurality of encrypted media keys included in the key management information main data to be deleted or modified.

The feature information calculating unit 17 has a function of calculating content feature information (content correspondence data) v composed of a data amount smaller than that content data C to be a encryption recording target stored in the storage device 11A and uniquely corresponded to the content data C. This content feature information v is transmitted to the license association apparatus 20A, together with a key issue request from the disc manufacturer apparatus 10A.

The content feature information v is required to be information capable of identifying content. For example, the content feature information v needs to be such a table which collects hash values H1, H2, through HL at every specified unit preset within a whole range so that each hash value H1-HL can be detected by indexed video object (VOB) 1-VOBL in one piece of the content data C, as shown in FIG. 4 and FIG. 5.

In the case of this table, the feature information v is defined as one in which hash values are collected from the whole range of the one piece of the content data C, but it is not limited to this and preferable to be one in which the hash values are collected within ranges appropriately thinned. However, if the feature information v is generated within the thinned ranges, some kind of injustice might occur within the range with the feature information v has not generated therein, so that it is preferable for the feature information v to be generated within the whole range of the one piece of content data C.

Since the feature information v is required to identify only the content, it needs to be calculated from either or both of plain content and encrypted content.

When verifying the feature information v, the feature information calculation unit 17 preferably detects the whole ranges, however, needs to verify by thinning appropriately. However, in the case of performing of thinned verification, some kind of injustice might occur within the range which has not detected yet, so that it is preferable to randomly determine a range to be detected.

The disc manufacturer apparatus 10A is assumed that it made an appropriate license agreement with a license association in advance.

On the other hand, the license association apparatus 20A has a storage device 22 and a signature unit 23 for signature of a public key encryption system in addition to the key management information generation unit 21 shown in FIG. 1.

According to this, the information generation unit 21 has a function of issuing the latest key management information MKB and the media key and a function of transmitting key management feature information (I_{add}, ID_{mkb}) uniquely corresponding to the latest key management information MKB to the signature unit 23, in accordance with the key issuing request received from the disc manufacturer apparatus 10A. The key management feature information (I_{add}, ID_{mkb}) is not limited to I_{add} and ID_{mkb} and needed to be information uniquely corresponded to the latest key management information MKB.

The storage device 22 is a memory to be read from the signature unit 23 and stores a private key of the public key encryption system therein.

The signature unit 23 has the following functions (f23-1)-(f23-2).

(f23-1): A function of making a concatenation between the key management feature information (I_{add}, ID_{mkb}) received from the key management information generation unit 21 and the feature information v received from the disc manufacturer apparatus 10A to generate concatenation data (v∥I_{add}∥ID_{mkb}).

(F23-2): A function of conducting signature processing to the concatenation data on the basis of the private key in the storage device 22 to generate a digital signature (the latest uniquely corresponded data) Sig [v∥ID_{mkb}∥I_{add}] uniquely corresponding to both feature information.

The signature processing can use a digital signature algorithm by an arbitrary public key encryption system such as a Rivest-Shamir-Adleman (RSA) cipher and an elliptic curved cipher. The signature processing and the digital signature algorithm are respectively examples, if the signature processing is a way capable of associating the key management information to be recorded on the recording disk with the content data C, the signature processing does not necessarily need to use the digital signature.

For example, hash function with a key needs to be used. Encryption algorithm to be used by the encryption unit 15A, the signature unit 23, etc., is not limited to one for a specific system, and a variety of encryption algorithms can be used.

The license association apparatus 20A has an additional function of sending back the latest key management information MKB and a media key Km acquired from the key management information generation unit 21 and the digital signature obtained from the signature unit 23 to the disc manufacturer apparatus 10A.

Data transmitting and receiving between the license association apparatus 20A and the disc manufacturer apparatus 10A can use an arbitrary transmitting and receiving system such as a method for communicating through a network such as the Internet and a method for delivering physical recording media. In the case of using the Internet, it is preferable to conduct an appropriate security measures (prevention of leakage, alteration of data and the like) in response to the transmitting and receiving system of data, for example, perform secure communications through a secure socket layer (SSL).

In the first embodiment, the license association apparatus 20A executes two processing of issuing of the key management information and generation the digital signature. However, not limited to these two processing, a modified configuration is acceptable, wherein these two processing is executed at different associations by determining processing procedures in advance. This modification goes same for the following each embodiment.

A DVD player device for playing a DVD 30A manufactured as stated above will be explained below. The DVD player device is manufactured by a player manufacturer who has made a license agreement with the license association 20A in accordance with license conditions. More specifically, the DVD player device is manufactured as a dedicated playback device composed of each device or a program (application software, etc.) installed from a computer readable recording medium to a personal computer (PC).

FIG. 6 is the schematic diagram showing the configuration of the DVD player device in the first embodiment. A DVD player device 40 has an extraction unit 41, a signature verification unit 42, a decryption unit 43, a feature information calculation unit 44, a feature information verification unit 45 and a playback control unit 46 as function blocks in addition to a usual playback function.

The extracting unit 41 has a function of extracting the key management feature information from the key management information MKB read from the DVD 30A and inputting the acquired key management feature information (I_{add}, ID_{mkb}) to the signature verification unit 42.

The signature verification unit 42 has a function of verifying validity by using a public key of a license association, the content feature information v read from the DVD 30A and the key management feature information input from the extraction unit 41 and a function of sending this verification result to the playback control unit 46 in relation to the digital signature read from the DVD 30A.

The decryption unit 43 has a function of decrypting the encrypted content read from the DVD 30A to send the obtained content data to the feature information calculation unit 44.

The feature information calculation unit 44 has a function of calculating content feature information v′ from content data sent from the decryption unit 43 to send the acquired content feature information v′ to the feature information verification unit 45.

The feature information verification unit 45 has a function of determining whether or not the content feature information v′ calculated by the feature information calculation unit 44 coincides with the content feature information v read from the DVD 30A to send the determination result to the playback control unit 46.

The playback control unit 46 has a function of prevent playback when at least one among verification results from the signature verification unit 42 and the feature information verification unit 45.

In the case that the DVD player device 40 is a PC and reproduces a disc by means of the software on the PC and also by means of the DVD drive connected to the PC, it is preferable for the data transmitted and received between the PC and the DVD drive to be appropriately protected on a transmission path if necessary.

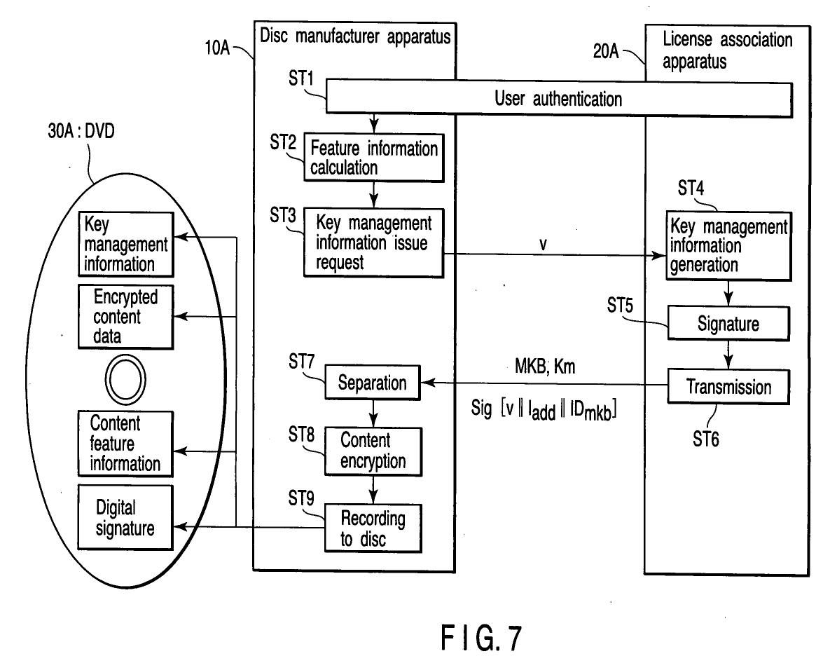

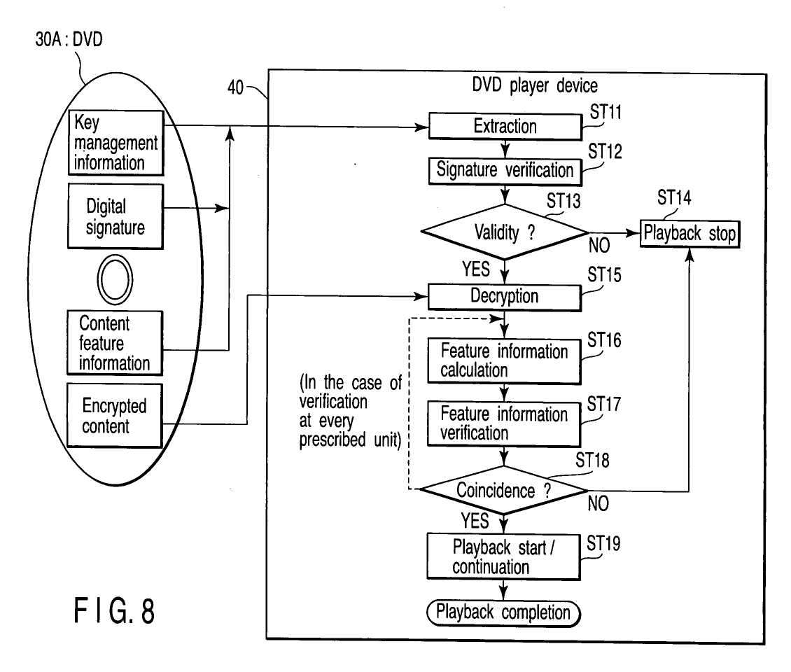

Then, operations of the disc manufacturer apparatus, the license association apparatus and the playback device configured as mentioned above will be explained in this sequence by referring to flowcharts in FIG. 7 and FIG. 8.

(Manufacturing Processing)

The disc manufacture apparatus 10A, as shown in FIG. 7, accesses to the license association apparatus 20A and conducts key exchange, etc., for user verification or transmission path protection by, for example, SSL (ST 1).

Subsequently, the disc manufacturer apparatus 10A reads the content data C to be an encryption recording target in the storage device 11A by means of the feature information calculation unit 17 and calculates the content feature information v with a data amount smaller than that of the content data C and uniquely corresponding to the content data C (ST 2).

Thereafter, the disc manufacturer apparatus 10A transmits a key issue request including the content feature information v to the license association apparatus 20A by means of a communication (not shown) (ST 3).

When receiving this key issue request, the license association apparatus 20A sends the key management feature information uniquely corresponding to the key management feature information MKB to the signature unit 23 as well as the key management information generation unit 21 issues the latest key management information MKB and the media key Km corresponding with each other (ST 4). As described here, the key management feature information is defined as the data (I_{add}, ID_{mkb}) consisting of the additional information I_{add} and the key management information identification information ID_{mkb}. The received content feature information v is input to the signature unit 23.

The signature unit 23 generates concatenation data (v∥I_{add}∥ID_{mkb}) by making the concatenation between the key management feature information (I_{add}, ID_{mkb}) and the content feature information v and conducts signature processing to the concatenation data on the basis of the private key in the storage device 22. Thereby, the signature 23 generates the digital signature (the latest unique correspondence data) Sig [v∥ID_{mkb}∥I_{add}] uniquely corresponding to both feature information (ST 5).

After such steps, the license association apparatus 20A transmits the latest key management information MKB, the media key Km and the digital signature Sig [v∥ID_{mkb}∥I_{add}] to the disc manufacturer apparatus 10A (ST 6).

When receiving the latest key management information MKB, the media key Km and the digital signature Sig [v∥ID_{mkb}∥I_{add}], the disc manufacturer apparatus 10A separates the media key Km from the received content by means of the separation unit 16 and transmits the media key Km to the encryption unit 15A (ST 7).

The encryption unit 15A generates encrypted content by encrypting the content data C in the storage device 11A on the basis of the media key Km (ST 8).

Thereafter, the disc manufacturer apparatus 10A writes the encrypted content, the digital signature Sig [v∥ID_{mkb}∥I_{add}], the latest key management information MKB and the content feature information v into the DVD 30A (ST 9).

(Playback Processing)

The DVD player device 40, as shown in FIG. 8, reads the content feature information v, the key management information MKB and the digital signature and inputs the content feature information v and the digital signature to the signature verification unit 42. The extraction unit 41 extracts the key management information (I_{add}, ID_{mkb}) from the read key management information MKB (ST 11) and inputs it to the signature verification unit 42.

The signature verification unit 42 verifies the validity of the digital signature on the basis of the content feature information v, the key management information MKB and the public key of the license association (ST12) and sends the verification result to the playback control unit 46.

If the verification result indicates the absence of the validity (NO in ST 13), the playback control unit 46 stops playback (ST 14). As described herein, the absence of the validity means the fact that a part of or a whole of data in the DVD 30A has been generated in falsely.

In contrast, the verification result from step ST 12 indicates the presence of validity (YES in ST 13), the decryption unit 43 decrypts the encrypted content read from the DVD 30A (ST 15) and sends the obtained content data to the feature information calculation unit 44.

The feature information calculating unit 44 calculates the content feature information v′ from this content data (ST16) and sends this feature information v′ to the feature information verification unit 45.

The verification unit 45 verifies this feature information v′ (ST 17). That is, the verification unit 45 determines whether or not the feature information v′ coincides with the content feature information v in the DVD 30A (ST 18), and sends the determination result to the playback control unit 46.

The playback control unit 46 returns back to step ST14 to stop the playback when the determination result indicates the fact that both the feature information v and v′ do not coincide with each other, in other words, an absence of the validity (NO in ST 13). Here, the absence of the validity means the fact that the feature information v or the encrypted content has been recorded in falsely.

In contrast, the determination result in step ST 18 indicates the coincidence between the feature information v and v′, the playback control unit 46 starts the playback of the content data (ST 19).

In the case that the content feature information v is calculated at every specified unit, the feature information verification unit 45 verifies the validity of the content by returning back to step ST16 at every specified unit. If the feature information verification unit 45 detects the point at which the feature information v and v′ do not coincide with each other on the way of playback, the playback control unit 46 stops the playback. However, in the case that a content playback circuit and a content feature information verification circuit (the feature information verification unit 45) are mounted separately with each other, there is a possibility of the playback of the content in advance of completion of the verification of the content feature information. It is needed to define whether such mounting should be allowed or not by an operation rule of the license.

According to the above-stated first embodiment, in advance of manufacturing of the DVD 30A by the disc manufacture apparatus 10A, the license association apparatus 20A generates the digital signature uniquely corresponding to the latest key management information and the content data. The disc manufacturer apparatus 10A writes the digital signature together with the key management information, the encrypted content and the content feature information into the DVD 30A.

Thereby, recording media manufactured without using the latest management information can be detected by verifying the unique correspondence among the key management information, the content feature information and the digital signature and unique correspondence between the encrypted content and the content feature information in advance of the playback, then, the accuracy of the content protection can be improved. If at least one verification result among these two verification results shows the absence of the validity, the playback of the recording media can be prevented, so that the accuracy of the content protection can be enhanced.

In addition to this, since the license association apparatus 20A generates the digital signature in response to the latest key management information, the regular DVD 30A uses the latest key management information intended by the license association apparatus 20A. Thereby, the first embodiment can disable all unauthorized equipment capable of being disabled by the latest key management information.

Since the first embodiment copes the latest key management information and content to be targeted by using the digital signature, the first embodiment can make a disc manufacturer use the key management information in accordance with the way of use fundamentally intended by the license association.

If the key management information which has not been intended by an issuer of the key management information such as old key management information is used, since the fact that the key management information which has not been intended can be detected from the result of signature verification caused by the DVD player device 40, the first embodiment can stop the playback of the DVD 30A.

### Second Embodiment

FIG. 9 is the schematic diagram showing the disc manufacturer apparatus and the license association apparatus regarding the second embodiment of the invention.

This second embodiment is a modified example of the first embodiment, which is different from the first embodiment to issue the key management information at every time of one title of disc and, similarly to a conventional technique, designed on the premise of collective issue of a plurality of pieces of key management information in advance. This premise is especially matches to such a case that key issuing procedures and signature procedures at the license association are separately managed.

A disc manufacturer apparatus 10B has an issue request unit 12, a storage device 13 and a key management selection unit 14B in addition to the foregoing each unit 11A, 17. An encryption unit 15B is designed to execute the above-mentioned encryption function, based on the media key Km corresponding to the key management information selected by the key management information selection unit 14B.

The issue request unit 12 transmits an issue request for a plurality of pieces of the key management information to a license association apparatus 20B in advance by an operation of a disc manufacturer similarly to the conventional technique.

The storage device 13 stores key management information sets received from the license association apparatus 20B and stores respective media keys, if necessary, and the key management selection unit 14B can read the information sets and the media keys. As used herein, the phrase “if necessary” means that it is not always necessary to store respective media keys. The reason is that if the media manufacturing apparatus has a device key (decryption key) of the key management information MKB similarly to a player, even the media manufacturing apparatus becomes possible to generate the media key Km. However, it is troublesome to obtain the media key Km from the key management information MKB, so that the storage device 13 is set to also store the media key Km together in advance.

The key management selection unit 14B has a function of selecting, for example, key management information MKBi as any key management information stored in the storage device 13.

The disc manufacturer apparatus 10B has a function of transmitting a signature request including the key management information identification information ID_{mkb} uniquely corresponding to the key management information MKBi acquired from the key management information selection unit 14B and the content feature information v acquired from the feature information calculation unit 17 to the license association apparatus (unique data generation apparatus) 20B.

The license association apparatus 20B has a key management information database 24 and a use availability determination unit 25 in addition to the each unit 21, 22 described above. Accordingly, a part of signature targets of a signature unit 13B becomes data to be received from the determination unit 25.

The key management information database 24 is a storage device with the key management information MKB1-MKBn, etc., generated by the key management information generation unit 21 stored therein and can be referred from the determination unit 25.

The determination unit 25 has the following functions (f25-1)-(f25-3).

(f25-1): A function of referring to the key management information DB 24 on the basis of the key management information identification information ID_{mkb} included in the signature request received from the disc manufacturer apparatus 10B and determining whether the relevant key management information MKB is available (the latest MKB) or not at this moment.

(f25-2): A function of stopping processing if the key management information MKB is not available.

(f25-3): A function of transmitting the identification information ID_{mkb} to the signature unit 23B if the key management information MKB2 is available.

The case that the key management information MKB2 is not available is, for example, the case that the key management information MKB2 is old one or the key management information which has been already used once.

The license association apparatus 20B has an additional function of transmitting the content feature information v received from the disc manufacturer apparatus 10B and the additional information I_{add} in the key management information DB 24 to the signature unit 23B according to the transmitting function (f25-3) in the determination unit 25.

The license association apparatus 20B can modify itself to transmit the additional information I_{add} to the signature unit 23B when receiving the additional information I_{add} from the disc manufacturer apparatus 10B. That is, the license association apparatus 20B becomes to have an additional function of transmitting necessary data to the signature unit 23B, when receiving the data necessary for signature from the disc manufacturer apparatus 10B. The license association apparatus 20B becomes to have an additional function of transmitting necessary data to the signature unit 23B, when not receiving the data necessary for the signature from the disc manufacturer apparatus 10B.

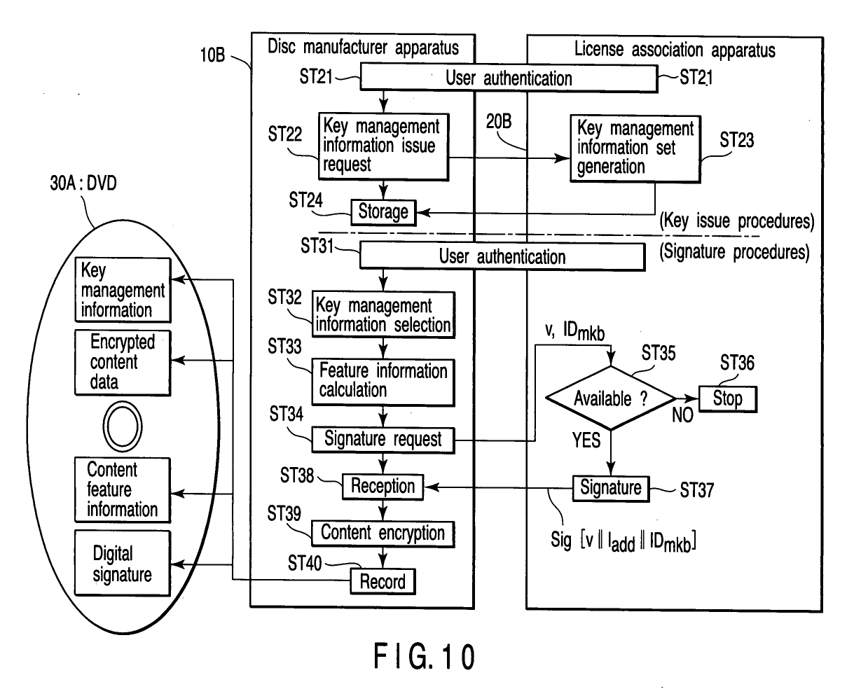

In subsequence, operations of the disc manufacturer apparatus 10B and the license association apparatus 20B configured stated above will be explained in order from manufacturing processing to playback processing by referring to the flowchart in FIG. 10.

(Manufacturing Processing)

The disc manufacturer apparatus 10B conducts user verification, key exchange for transmission path protection, etc., between the license association apparatus 20B as shown in FIG. 10 as stated above (ST 21).

The disc manufacturer apparatus 10B previously transmits the issue request for the plurality of pieces of key management information by means of the issue request unit 12 with operations of the disc manufacturer (ST 22).

The license association apparatus 20 generates the key management information sets MKB1-MKBn composed of n pieces of key management information by means of the key management generation unit 21 on the basis of the issue request (ST 23). Suites (MKB1, Km1), (MKB2, Km2) through (MKBn, Kmn) of the key management information sets MKB1-MKBn and the corresponding media key Km1-Kmn are sent back to the disc manufacturer apparatus 10B from the license association apparatus 20B.

The disc manufacturer apparatus 10B stores the suits (MKB1, Km1), (MKB2, Km2) through (MKBn, Kmn) in the storage device 13 (ST 24).

The processing of key issue procedures have just completed as stated above. The steps (ST 21-ST 24) are the same as those of the conventional technique. The process of the signature procedures will be explained below.

The disc manufacturer apparatus 10B performs the user authentication, the key exchange for the transmission path protection, etc., between the license association apparatus 20B as mentioned above (ST 31).

Next, the disc manufacturer apparatus 10B selects by means of the key management information selection unit 14B, for example, the key management information MKB2 as any key management information stored in the storage device 13 (ST 32).

The feature information calculation unit 17 reads the content data C to be an encryption recording target stored in the storage device 11A and calculates the content feature information v uniquely corresponding to the content data C (ST 33). The data amount of the content feature information v is smaller than that of the content data C.

After this, the disc manufacturer apparatus 10B transmits the signature request including the key management information identification information ID_{mkb} uniquely corresponding to the selected key management information MKB2 and the calculated content feature information v (ST 34). Wherein, the key management information identification information to be transmitted is not defined as a whole of information used for signature processing in step 37 described later, but may be limited only to information capable of identifying the key management information MKB2.

The license association apparatus 20B refers to the key management information database 24 by means of the use availability determination unit 25 on the basis of the key management information identification information ID_{mkb} included in this signature request and determines whether or not the key management information MKB2 is available (the latest MKB) at this moment (ST 35). As this determination result, the license association apparatus 20B stops processing in the case that the key management information MKB2 is not available (ST 36).

As the determination result from step ST 35, if the key management information MKB2 is available, the determination unit 25 transmits the identification information ID_{mkb} to the signature unit 23B. The license association apparatus 20B transmits the content feature information v received from the disc manufacturer apparatus 10B and the additional information I_{add} stored in the key management information DATABASE 24 to the signature unit 23B.

The signature unit 23B executes the signature processing to the content feature information v, the additional information I_{add} and the identification information ID_{mkb} on the basis of the private key stored in the storage device 22 (ST 37) and generates digital signature Sig (v∥I_{add}∥ID_{mkb}). The digital signature Sig (v∥I_{add}∥ID_{mkb}) is sent back to the disc manufacturer apparatus 10B from the license association apparatus 20B.

When receiving the digital signature, the disc manufacturer apparatus 10B encrypts, by means of the encryption unit 15B, the content data C in the storage device 11A on the basis of the media key Km2 corresponding to the key management information MKB2 selected in step ST 32 and generates the encrypted content (ST 39).

Thereafter, the disc manufacturer apparatus 10B writes these encrypted content, the digital signature, the selected key management information and the content feature information into the DVD 30A (ST 40).

(Playback Processing)

The playback processing is as stated for the first embodiment.

According to the foregoing second embodiment, when the disc manufacturer apparatus 10B manufactures the DVD 10A, the apparatus 10B selects any key management information stored in the storage device 13 contrary to the first embodiment, and the license association apparatus 20B determines the availability of use of the selected key management information and generates the digital signature if the key management information is available. However, similarly to the first embodiment, in the successive configuration other than the described above, the disc manufacturer apparatus 10B is configured to write the encrypted content, the digital signature, the selected key management information and the content feature information v into the DVD 30A, so that the second embodiment can obtain effect similar to the first embodiment.

The method exhibited in each above-mentioned embodiment can be distributed as a computer executable program by storing into a storage medium such as a magnetic disk [floppy disk (registered trade mark), hard disk, etc.], an optical disk (CD-ROM, DVD, etc.), a magnet-optical disk (MO) and a semiconductor memory.

Regardless of type of storage format, any storage medium capable of storing the program and being read by the computer is usable as the storage medium for this program.

An operating system (OS) or middleware (MW) such as a database management software and a network software running on the computer, based on the instruction installed in the computer from the storage medium, may executes a part of each processing to achieve each above-described embodiment.

The storage medium for the invention is not limited to a medium independent from the computer, and includes the storage medium with a program transmitted via a LAN, the Internet, etc., downloaded and stored or temporarily stored thereon.

The number of the storage medium for the invention is not limited only one, and the storage medium of the invention includes the case that processing in each embodiment is respectively executed by means of a plurality of media, and any structure of the medium is acceptable.

The computer in the invention executes each processing in each above mentioned embodiment, based on the program stored in the storage medium. Any configuration of the computer such as a device composed of a single personal computer, etc., and a system composed of a plurality of devices network-connected therein are available.

The computer in the invention is not limited to a personal computer, and includes computing processing device, a micro-computer, etc., included in information processing equipment and generically means equipment and a device capable of achieving the functions of the invention.

The invention in its broader aspects is not limited to the specific details and representative embodiments shown and described herein, and can be embodied in their implementation phases by modifying constituent components without departing from the spirit or scope of the general inventive concept of the invention. A variety of modifications of the invention may be made by appropriate combinations of a plurality of constituent components shown in each foregoing embodiment. For example, some constituent components may be omitted from the whole of the constituent components shown in each embodiment. Furthermore, the constituent components over different embodiments can be appropriately combined.

What is claimed is:

1. A method for protecting content using a key issuing device for issuing key management information and a media key corresponding to each other, and a media manufacturing apparatus for manufacturing recording media by recording encrypted content in which content data is encrypted to be decrypted on the basis of the media key and the key management information so as to generate the media key by means of an authorized playback device other than an unauthorized playback device onto recording media so as to prevent the encrypted content from being played by the unauthorized playback device, the method comprising:
generating the latest uniquely corresponded data uniquely corresponding to the latest key management information and the content data by means of the key issuing device in advance of manufacturing of the recording media; and
writing the latest uniquely corresponded data together with the key management information and the encrypted content to the recording media by means of the media manufacturing apparatus.

2. The method according to claim 1, wherein generating of the latest uniquely corresponded data includes:
receiving content correspondence data composed of a data amount smaller than that of the content data and uniquely corresponding to the content data from the media manufacturing apparatus; and
calculating the latest uniquely corresponded data on the basis of key management information correspondence data composed of a data amount smaller than that of the content data and uniquely corresponded to the key management information and the content correspondence data, and
writing to the recording media includes: writing the content correspondence data together with the key management information and the encrypted content onto the recording medium.

3. A media manufacturing apparatus for manufacturing recording media by recording an encrypted content in which content data is encrypted to be decrypted on the basis of a media key and key management information so as to generate the media key by means of an authorized playback device other than an unauthorized playback device onto recording media, the media manufacturing apparatus being in communication with a key issuing device, the key issuing device capable of issuing key management information and a media key corresponding to each other and generating the latest uniquely corresponded data uniquely corresponding to the issued key management information and the content data, the media manufacturing apparatus comprising:
a content correspondence data generation device configured to generate content correspondence data composed of a data amount smaller than that of the content data and uniquely corresponding to the content data;
a key issue request transmitting device configured to transmit a key issue request including the content correspondence data to the key issuing device;
a latest information reception device configured to receive the latest key management information, the media key and the latest uniquely corresponded data from the key issuing device in accordance with transmission of the key issue request;
an encrypted content generation device configured to generate the encrypted content on the basis of the media key; and
a writing device configured to write the encrypted content, the latest uniquely corresponded data, the latest key management information and the content correspondence data onto the recording media.

4. A media manufacturing apparatus for manufacturing recording media by recording encrypted content in which content data is encrypted to be decrypted on the basis of a media key and key management information so as to generate the media key by means of an authorized playback device other than an unauthorized playback device onto a recording media, the media manufacturing apparatus being in communication with a unique data generation device, the unique data generation device capable of generating the latest uniquely corresponded data uniquely corresponding to the latest key management information and the content correspondence data, the media manufacturing apparatus comprising:
a storage device configured to store a plurality of pairs of key management information and the media key if necessary in a pair of key management information and the media key corresponding to each other;
a key management information selection device configured to select any key management information stored in the storage device;
a content correspondence data generation device configured to generate content correspondence data composed of a data amount smaller than that of the content data and uniquely corresponding to the content data;
a unique data generation request transmitting device configured to transmit a unique data generation request including key management correspondence information uniquely corresponding to the selected key management information and the generated content correspondence data to the unique data generation device;
a latest uniquely corresponded data reception device configured to receive the latest uniquely corresponded data from the unique data generation device;
an encrypted content generation device configured to generate the encrypted content on the basis of the media key corresponding to the selected key management information; and
a writing device configured to write the encrypted content, the latest uniquely corresponded data, the selected key management information and the content correspondence data onto the recording media.

5. A playback device for decrypting encrypted content and playing obtained content data on the basis of a recording media with: the encrypted content in which the content data is encrypted so as to be decrypted on the basis of a media key; content correspondence data composed of a data amount smaller than that of the content data and uniquely corresponding to the content data; the latest key management information so as to generate the media key; and the latest uniquely corresponded data uniquely corresponding to the key management correspondence information uniquely corresponding to the latest key management information and the content correspondence data recorded thereon, the playback device comprising:
a first verification device configured to verify validity of the content correspondence data and key management information read from the recording media on the basis of the latest uniquely corresponded data read from the recording media;
a content correspondence data generation device configured to generate the content correspondence data on the basis of the encrypted content data read from the recording media;
a second verification device configured to verify validity of the generated content correspondence data on the basis of the content correspondence data in the recording media; and
a playback prevention device configured to prevent the playback when at least one of verification results from the first and the second verification devices indicates an absence of the validity.

6. A program used for a computer of a media manufacturing apparatus for manufacturing recording media by recording encrypted content in which content data in a memory is encrypted to be decrypted on the basis of a media key and key management information so as to generate the media key by means of an authorized playback device other than an unauthorized playback device and stored in a computer readable recording medium, the media manufacturing apparatus being in communication with a key issuing device, the key issuing device capable of issuing the key management information and the media key corresponding to each other and generating the latest uniquely corresponded data uniquely corresponding to the content correspondence data, the program comprising:
a first program code for making the computer execute processing to generate content correspondence data composed of a data amount smaller than that of the content data in the memory and uniquely corresponding to the content data;
a second program code for making the computer execute processing to transmit a key issue request including the content correspondence data to the key issuing device;
a third program code for making the computer execute processing to receive the latest key management information, the media key and the latest uniquely corresponded data from the key issuing device in accordance with transmission of the key issue request;
a fourth program code for making the computer execute processing to generate the encrypted content on the basis of the media key; and
a fifth program code for making the computer execute processing to write the encrypted content, the latest uniquely corresponded data, the latest key management information and the content correspondence data into the recording media.

7. A program used for a computer of a media manufacturing apparatus for manufacturing recording media by recording encrypted content in which content data is encrypted to be decrypted on the basis of a media key and key management information so as to generate the media key by means of an authorized playback device other than an unauthorized playback device and stored in a computer readable recording medium, the media manufacturing apparatus being in communication with a unique data generation device, the unique data generation device capable of the latest uniquely corresponded data uniquely corresponding to the latest key management information and the content correspondence data, the program comprising:
a first program code for making the computer execute processing to write a plurality of pairs of key management information and the media key into a memory in a pair of the key management information and the media key corresponding to each other;
a second program code for making the computer execute processing to select any key management information stored in the memory;
a third program code for making the computer execute processing to generate content correspondence data composed of a data amount smaller than that of the content data and uniquely corresponding to the content data;
a fourth program code for making the computer execute processing to transmit a unique data generation request including key management correspondence information uniquely corresponding to the selected key management information and the generated content correspondence data to the unique data generation device;
a fifth program code for making the computer execute processing to receive the latest uniquely corresponded data from the unique data generation device;
a sixth program code for making the computer execute processing to generate the encrypted content on the basis of the media key corresponding to the selected key management information; and
a seventh program code for making the computer execute processing to write the encrypted content, the latest uniquely corresponded data, the selected key management information and the content correspondence data.

8. A program stored in a computer readable recording medium for use in a computer of a playback device for decrypting encrypted content and playing obtained content data on the basis of a recording medium with: the encrypted content in which the content data is encrypted so as to be decrypted on the basis of a media key; content correspondence data composed of a data amount smaller than that of the content data and uniquely corresponding to the content data; the latest key management information so as to generate the media key; and the latest uniquely corresponded data uniquely corresponding to key management correspondence information uniquely corresponding to the latest key management information and the content correspondence data recorded thereon, the program comprising:
a first program code for making the computer execute first verification processing to verify validity of the content correspondence data and key management information read from the recording media on the basis of the latest uniquely corresponded data read from the recording media;
a second program cord for making the computer execute second verification processing to generate the content correspondence data on the basis of the encrypted content data read from the recording media;
a third program cord for making the computer execute processing to verify validity of the generated content correspondence data on the basis of the content correspondence data in the recording media; and
a fourth program code for making the computer execute processing to prevent the playback when at least one of verification results among the first and the second verification processing indicates an absence of the validity.
